(19) United States
(12) Patent Application Publication
(10) Pub. No.: US 2026/0308345 A1
(43) Pub. Date: Oct. 8, 2026

(54) CHEMICAL FOAMING OF INTERIOR COMPONENTS

(71) Applicant: GM GLOBAL TECHNOLOGY OPERATIONS LLC, Detroit, MI (US)

(72) Inventors: Russell Ankenbrandt, Troy, MI (US); Jaime S. Hollatz, Clarkston, MI (US); Israel Lopez-Gonzalez, Warren, MI (US)

(73) Assignee: GM GLOBAL TECHNOLOGY OPERATIONS LLC, Detroit, MI (US)

(21) Appl. No.: 19/169,496

(22) Filed: Apr. 3, 2025

(51) Int. Cl. C08J 9/00; B29C 44/34; B29C 44/56; B29C 44/60; B29K 23/00; B29K 55/02; B29K 105/04; B29L 31/30; C08J 5/12; C08J 9/08; C08J 9/34; C08L 23/06; C08L 23/12; C08L 55/02

(52) U.S. Cl. CPC C08J 9/0061; B29C 44/3415; B29C 44/5681; B29C 44/60; C08J 5/124; C08J 9/08; C08J 9/34; C08L 23/06; C08L 23/12; C08L 55/02; B29K 2023/06; B29K 2023/12; B29K 2055/02; B29K 2105/041; B29L 2031/3041; C08J 2203/02; C08J 2205/044; C08J 2323/06; C08J 2323/12; C08J 2355/02; C08L 2203/14; C08L 2205/025; C08L 2205/03

(57) ABSTRACT

Disclosed is a method of using a chemical foaming agent to make a vehicle interior trim wrapped component having reduced weight.

### INTRODUCTION

The technical field generally relates to vehicle interior trim components, and methods of making the same.

Vehicle interior trim components have been made by a variety of methods.

It is desirable to provide a method to make a vehicle interior trim component having reduced weight. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including: a mixture including a moldable resin, and an endothermic chemical foaming agent, the endothermic chemical foaming agent being formulated to produce microcells in a substrate molded from the mixture.

A number of variations may include a product wherein the moldable resin includes at least one of a thermoplastic polyolefin resin or an acrylonitrile butadiene styrene resin.

A number of variations may include a product wherein the moldable resin is present in about 97 to about 99 weight percent of the mixture.

A number of variations may include a product wherein the endothermic chemical foaming agent is present in about 1 to about 2 weight percent of the mixture.

A number of variations may include a product wherein the moldable resin includes the thermoplastic polyolefin resin.

A number of variations may include a product wherein the moldable resin includes an acrylonitrile butadiene styrene resin.

A number of variations may include a product wherein the thermoplastic polyolefin resin includes polypropylene, rubber, and polyethylene, and wherein the endothermic chemical foaming agent comprises sodium bicarbonate and citric acid.

A number of variations may include a method including; mixing a moldable resin and an endothermic chemical foaming agent to provide a mixture; injecting the mixture into an injection molding machine; heating the mixture to activate the endothermic chemical foaming agent to produce microcells in the mixture; pressing the mixture to produce a molded substrate for a vehicle interior trim component having the microcells in the molded substrate; and removing the molded substrate for a vehicle interior trim component from the injection molding machine.

A number of variations may include a method further including controlling the heating the mixture so that the molded substrate for the vehicle interior trim component has an outer surface free of bubbles, blemishes, or voids.

A number of variations may include a method further including wrapping the molded substrate for the vehicle interior trim component with a wrapping material.

A number of variations may include a method wherein the wrapping material includes at least one of a leather, silicone film, vinyl or faux leather, fabric, or suede.

A number of variations may include a method wherein the wrapping the molded substrate for the vehicle interior trim component with a wrapping material includes at least one of foam in place wrapping, in-mold graining wrapping, in-mold graining laminating, hand wrapping, or machine wrapping.

A number of variations may include a method further including depositing an adhesive on at least a portion of the outer surface of the molded substrate prior to wrapping the molded substrate for the vehicle interior trim component with a wrapping material so that the wrapping material adheres to the at least a portion of the outer surface of the molded substrate.

A number of variations may include a method further including controlling the heating so that the molded substrate for the vehicle interior trim component so that the microcells are present in the molded substrate for the vehicle interior trim component in an amount of at least one million microcells per cubic centimeter of the molded substrate for the vehicle interior trim component.

A number of variations may include a method wherein the microcells have a width ranging from about 0.1 to about 100 micrometers, and wherein the endothermic chemical foaming agent comprises sodium bicarbonate and citric acid.

A number of variations may include a product including: a vehicle interior trim component including a molded substrate including a molded resin, wherein the molded substrate includes microcells, the molded substrate having an outer surface free of bubbles, blemishes, or voids.

A number of variations may include a product further including a wrapping material on at least a portion of the outer surface of the molded substrate, wherein the wrapping material includes at least one of a leather, silicone film, vinyl leather, faux leather, fabric, or suede.

A number of variations may include a product wherein the vehicle interior trim component includes at least one of a thermoplastic polyolefin or an acrylonitrile butadiene styrene.

A number of variations may include a product wherein the vehicle interior trim component includes a dashboard, steering wheel, instrument panel, center console, kick panel, armrest, seat, door trim, A-pillar, B-pillar, C-pillar, or headliner.

A number of variations may include a product further including a vehicle, and wherein a vehicle interior trim component is installed in the vehicle, wherein the vehicle interior trim component includes a dashboard, steering wheel, instrument panel, center console, kick panel, armrest, seat, door trim, A-pillar, B-pillar, C-pillar, or headliner, wherein the vehicle interior trim component includes at least one of a thermoplastic polyolefin or an acrylonitrile butadiene styrene, wherein a wrapping material is on at least a portion of an outer surface of the molded substrate, wherein the wrapping material includes at least one of a leather, silicone film, vinyl leather, faux leather, fabric, or suede, wherein the microcells are present in the molded substrate in an amount of at least one million microcells per cubic centimeter of the molded substrate, wherein the microcells have a width ranging from about 0.1 to about 100 micrometers.

### BRIEF DESCRIPTION OF THE DRAWINGS

The illustrative variations will hereinafter be described in conjunction with the following drawing figures, wherein like numerals denote like elements, and wherein:

FIG. 1 is a flow chart of a method of making a molded substrate for use as a vehicle interior trim component according to a number of variations;

FIG. 2 is a schematic illustration of a molded substrate for a vehicle interior trim component without the wrapping material thereon according to a number of variations;

FIG. 3 is a schematic illustration of the molded substrate for a vehicle interior trim component shown in FIG. 2 with a wrapping material on portions thereof according to a number of variations;

FIG. 4 is a partial, sectional view of a molded substrate for a vehicle interior trim component without a wrapping material thereon showing microcells formed in the molded substrate for a vehicle interior trim component according to a number of variations;

FIG. 5 is a schematic illustration of a portion of the interior of a vehicle including vehicle interior trim components according to a number of variations; and

FIG. 6 is a schematic illustration of a vehicle showing interior trim components according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

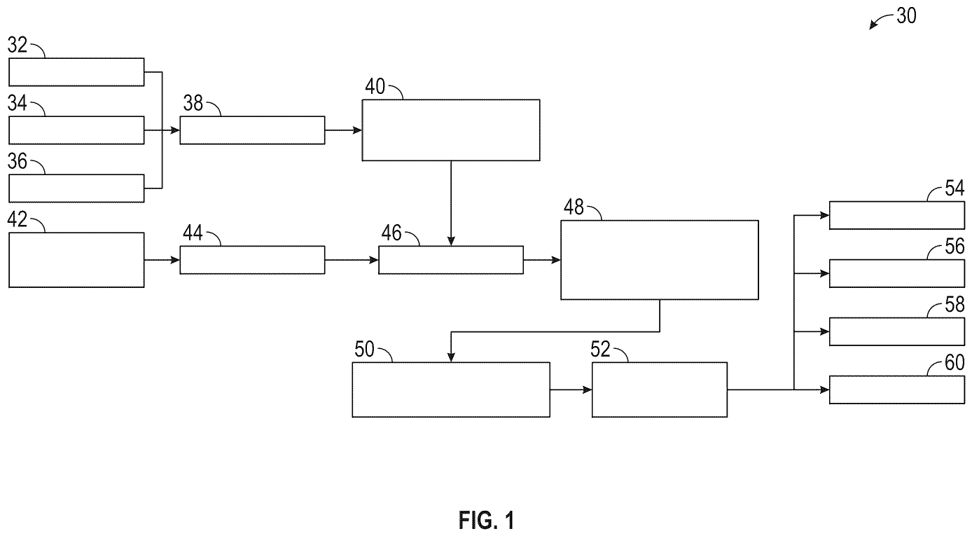

FIG. 1 is a flow chart of a method 30 of making a molded substrate for use as a vehicle interior trim component. The method 30 may include providing, at box 32, a colorant, at box 34, a resin material, and at box 36, an endothermic chemical foaming agent and placing the each in a hopper or blender, at box 3. Thereafter moving the colorant, the resin material, and the endothermic chemical foaming agent from the hopper or blender to a screw rotate mixing device at box 42 and mixing the same to provide a mixture. At box 42 injection mold may be opened at box 42 and thereafter closed at box 44 with or without a mold insert. Thereafter, the mixture may be injected into the mold at box 40. Thereafter, at box 48, the temperature and pressure of the mold may be controlled to activate the chemical foaming agent to produce microcells in a substrate molded in the mold. The temperature of the molding process may be controlled by any of a variety of heating sources so that the chemical foaming agent produces carbon dioxide at a rate and amount to produce the microcells in the substrate molded in the mold. Thereafter, at box 50, the substrate may be de-molded and the mold opened in the substrate ejected from the mold. Thereafter, at box 52, a wrapping process may be used to wrap the molded substrate may be wrapped with a material, such as but not limited to, leather, silicone film, vinyl and faux leather, fabric, or suede. The molded substrate may be wrapped by a method of foam in place, at box 54, in-mold graining or in-mold graining laminate, at box 56, hand wrapping, at box 58, or machine wrapping, at box 60.

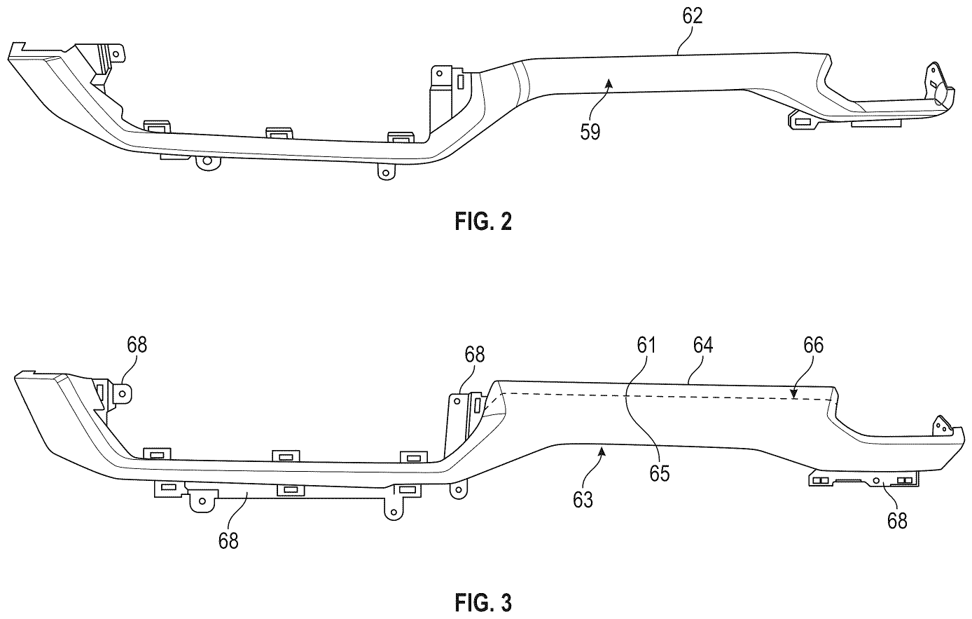

FIG. 2 is a schematic illustration of a molded substrate 62 for a vehicle interior trim component without the wrapping material thereon according to a number of variations. The molded substrate 62 may be made from the composition including at least one of a thermoplastic polyolefin resin or an acrylonitrile butadiene styrene resin. The thermoplastic polyolefin resin may be the blend of polypropylene, a rubber, and a polyethylene. The rubber may be an un-crosslinked ethylene propylene diene monomer. The thermoplastic polyolefin resin may include talc, may be heat stabilized, may have a high stiffness, and/or may have a high impact strength property. The thermoplastic polyolefin resin may be present in about 97 to about 99 weight percent of the composition. The acrylonitrile butadiene styrene resin may be ultraviolet light stabilized and/or may be heat stabilized. The acrylonitrile butadiene styrene resin may be present in about 97 to about 99 weight percent of the composition.

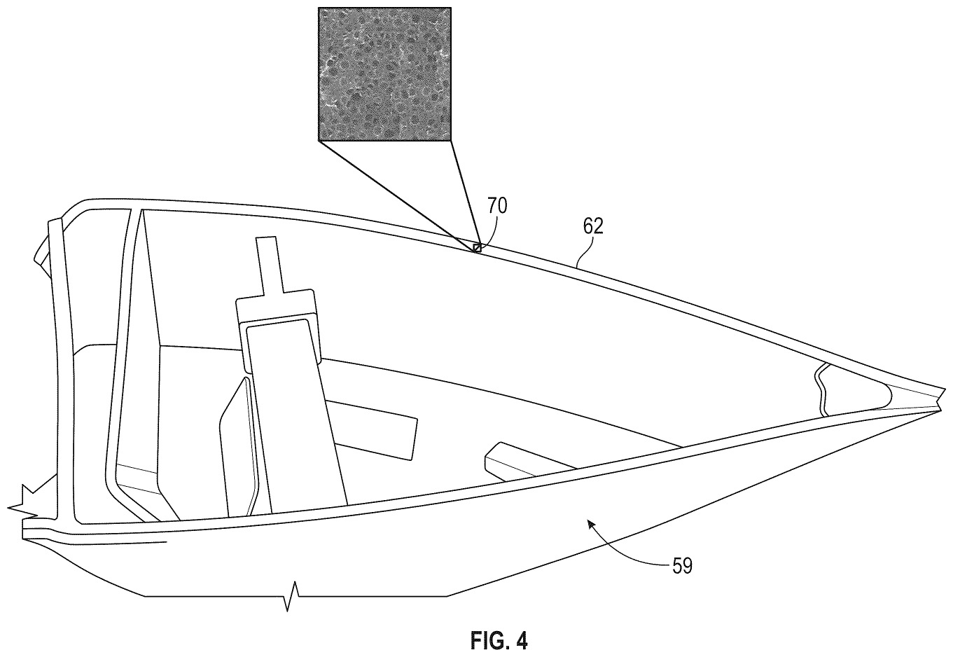

The composition may include an endothermic chemical foaming agent that, when activated in the mold creates microcells 70 (best shown in FIG. 3) in the molded substrate 62 and may not produce outgas that can produce bubbles, blemishes, or voids in an outer surface 59 of the molded substrate. The activation of the endothermic chemical agent may be controlled to produce a molded substrate 62 that has an outer surface 59 free of bubbles, blemishes, or voids. Because the outer surface 59 of the molded substrate 62 is free of bubbles, blemishes, or voids the wrapping process and the wrapped molded substrate are improved. The microcells in the molded substrate may have a width ranging from about 0.1 to about 100 micrometers. There may be more than one million cells in a cubic centimeter of the molded substrate. During an endothermic reaction, the chemical foaming agent may release carbon dioxide and may release trace amount of water. To inactive the chemical foaming agent the mold may be heated so that the injected composition is above the activation temperature of the chemical foaming agent. The activation temperature of the chemical foaming agent may range from about 80 degrees Fahrenheit to about 400 degrees Fahrenheit. The chemical foaming agent may be present in about 1 to about 3 weight percent of the composition. Using a chemical forming agent in the molding process may reduce the weight of the molded substrate by up to 25 weight percent compared to molded substrate produce without using a chemical foaming agent.

In a number of variations, a suitable endothermic chemical foaming agent may include sodium bicarbonate and may include citric acid. Suitable chemical foaming agents are commercially available from ID Actives company under the tradenames 74837 ID FOAM 20 MFC and 74979 ID FOAM HIGH TEMP ENDO 6672, from Mitsubishi Corporation under the tradenames EIWA H2710 and EIWA HES463, from Trexel Inc. under the tradenames TecoCell H1 and TecoCell GTA, and from Avient Corporation under the tradenames Hydrocerol 818 and Hydrocerol HK40 available.

A composition including thermoplastic polyolefin resin may be molded at a temperature ranging from about 80 degrees Fahrenheit to about 150 degrees Fahrenheit and may be held at a pressure ranging from about 20 psi to about 100 psi.

A composition including an acrylonitrile butadiene styrene resin may be molded at a temperature ranging from about 80 degrees Fahrenheit to about 150 degrees Fahrenheit and may be held at a pressure ranging from about 20 psi to about 100 psi.

FIG. 3 is a schematic illustration of the molded substrate 62 for a vehicle interior trim component shown in FIG. 2 with a wrapping material 64 on portions thereof according to a number of variations. An adhesive (not shown) may be deposited on at least a portion of molded substrate 62 for a vehicle interior trim component shown in FIG. 2 and a wrapping material 64 may be placed on the adhesive to attached/adhere the wrapping material 64 to the molded substrate for a vehicle interior trim component The ends 61, 65 of the wrapping material 64 may be connected together with stitching 66. The molded substrate 62 may have unwrapped portions 68.

FIG. 4 is a partial, sectional view of a molded substrate 62 for a vehicle interior trim component without a wrapping material thereon. Microcells 70 may be formed in the molded substrate 62 for a vehicle interior trim component according to a number of variations.

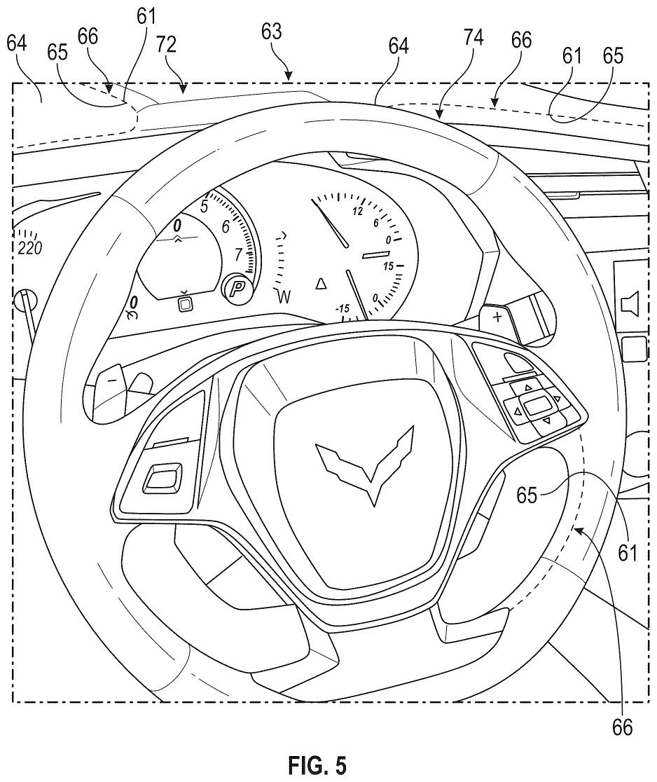

FIG. 5 is a schematic illustration of a portion of the interior of a vehicle including vehicle interior trim components 63 according to a number of variations. In a number of variations, the vehicle interior trim component 63 may be a dashboard 72 which may include ends 61, 65 of a wrapping material 64 connected together by stitching 66. In a number of variations, the vehicle interior trim component 63 may be a steering wheel 74 having ends 61, 65 of a wrapping material 64 connected together by stitching 66. A molded substrate 62 for the interior trim component is not visible because of the wrapping material 64 in each of the dashboard 72 and steering wheel 74.

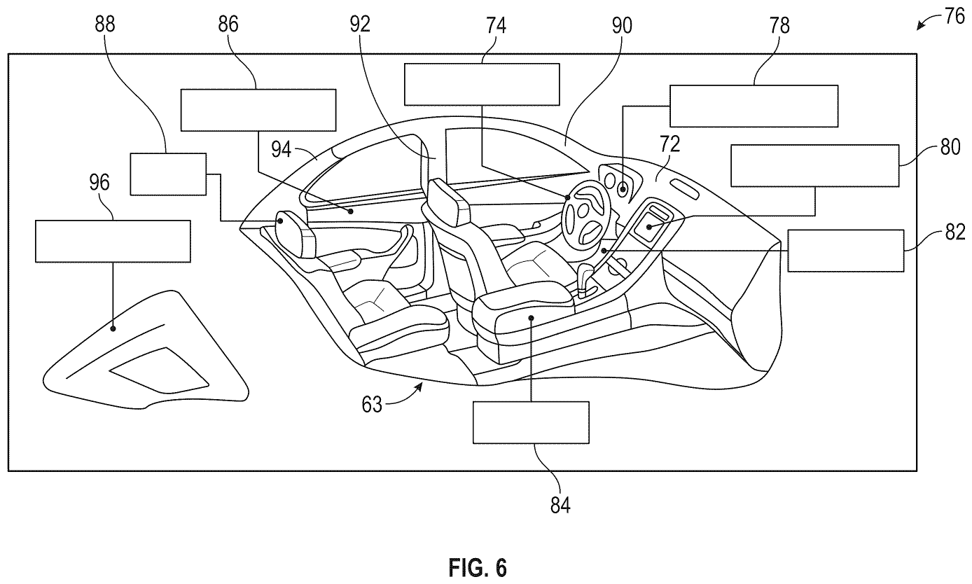

FIG. 6 is a schematic illustration of a vehicle 76 showing vehicle interior trim components 63 according to a number of variations. Vehicle interior trim components 63 including a molded substrate 62 and a wrapping material 64 (best seen in FIGS. 3 and 5) thereon as disclosed herein may include, but not limited to, a dashboard 72, steering wheel 74, instrument panel 78, center console 80, kick panel 82, armrest 84, seat 88, door trim 86, A-pillar 90, B-pillar 92, C-pillar 94, and/or headliner 96. Other interior trim components such as a mirror, sun visor, shade, and the like may also include a molded substrate 62 and a wrapping material 64 thereon.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
a mixture comprising a moldable resin, and an endothermic chemical foaming agent, the endothermic chemical foaming agent being formulated to produce microcells in a substrate molded from the mixture.

2. The product as set forth in claim 1 wherein the moldable resin comprises at least one of a thermoplastic polyolefin resin or an acrylonitrile butadiene styrene resin.

3. The product as set forth in claim 2 wherein the moldable resin is present in about 97 to about 99 weight percent of the mixture.

4. The product as set forth in claim 3 wherein the endothermic chemical foaming agent is present in about 1 to about 3 weight percent of the mixture.

5. The product as set forth in claim 2 wherein the moldable resin comprises the thermoplastic polyolefin resin.

6. The product as set forth in claim 2 wherein the moldable resin comprises an acrylonitrile butadiene styrene resin.

7. The product as set forth in claim 4 wherein the thermoplastic polyolefin resin comprises polypropylene, rubber, and polyethylene, and wherein the endothermic chemical foaming agent comprises sodium bicarbonate and citric acid.

8. A method comprising;
mixing a moldable resin and an endothermic chemical foaming agent to provide a mixture;
injecting the mixture into an injection molding machine;
heating the mixture to activate the endothermic chemical foaming agent to produce microcells in the mixture;
pressing the mixture to produce a molded substrate for a vehicle interior trim component having the microcells in the molded substrate; and
removing the molded substrate for a vehicle interior trim component from the injection molding machine.

9. The method as set forth in claim 8 further comprising controlling the heating the mixture so that the molded substrate for the vehicle interior trim component has an outer surface free of bubbles, blemishes, or voids.

10. The method as set in claim 9 further comprising wrapping the molded substrate for the vehicle interior trim component with a wrapping material.

11. The method as set forth in 10 wherein the wrapping material comprises at least one of a leather, silicone film, vinyl or faux leather, fabric, or suede.

12. The method as set forth in claim 10 wherein the wrapping the molded substrate for the vehicle interior trim component with the wrapping material comprises at least one of foam in place wrapping, in-mold graining wrapping, in-mold graining laminating, hand wrapping, or machine wrapping.

13. The method as set forth in claim 12 further comprising depositing an adhesive on at least a portion of the outer surface of the molded substrate prior to wrapping the molded substrate for the vehicle interior trim component with a wrapping material so that the wrapping material adheres to the at least a portion of the outer surface of the molded substrate.

14. The method as set forth in claim 8 further comprising controlling the heating so that the molded substrate for the vehicle interior trim component so that the microcells are present in the molded substrate for the vehicle interior trim component in an amount of at least one million microcells per cubic centimeter of the molded substrate for the vehicle interior trim component.

15. The method as set forth in claim 8 wherein the microcells have a width ranging from about 0.1 to about 100 micrometers, and wherein the endothermic chemical foaming agent comprises sodium bicarbonate and citric acid.

16. A product comprising:
a vehicle interior trim component comprising a molded substrate comprising a molded resin, wherein the molded substrate includes microcells, the molded substrate having an outer surface free of bubbles, blemishes, or voids.

17. The product as set forth in claim 16 further comprising a wrapping material on at least a portion of the outer surface of the molded substrate, wherein the wrapping material comprises at least one of a leather, silicone film, vinyl leather, faux leather, fabric, or suede.

18. The product as set forth in claim 16 wherein the vehicle interior trim component comprises at least one of a thermoplastic polyolefin or an acrylonitrile butadiene styrene.

19. The product as set forth in claim 16 wherein the vehicle interior trim component comprises a dashboard, steering wheel, instrument panel, center console, kick panel, armrest, seat, door trim, A-pillar, B-pillar, C-pillar, or headliner.

20. The product as set forth in claim 16 further comprising a vehicle, and wherein the vehicle interior trim component is installed in the vehicle, wherein the vehicle interior trim component comprises a dashboard, steering wheel, instrument panel, center console, kick panel, armrest, seat, door trim, A-pillar, B-pillar, C-pillar, or headliner, wherein the vehicle interior trim component comprises at least one of a thermoplastic polyolefin or an acrylonitrile butadiene styrene, wherein a wrapping material is on at least a portion of the outer surface of the molded substrate, wherein the wrapping material comprises at least one of a leather, silicone film, vinyl leather, faux leather, fabric, or suede, wherein the microcells are present in the molded substrate in an amount of at least one million microcells per cubic centimeter of the molded substrate, wherein the microcells have a width ranging from about 0.1 to about 100 micrometers.
